(19) United States
(12) Patent Application Publication
(10) Pub. No.: US 2026/0067539 A1
(43) Pub. Date: Mar. 5, 2026

(54) AUTOPLAY CONFIGURATION

(71) Applicant: Meta Platforms Technologies, LLC, Menlo Park, CA (US)

(72) Inventors: Justin Angel, San Francisco, CA (US); Yen Kuang Chen, Long Island City, NY (US); Tyler Matthews, Oro Valley, AZ (US); Ameet Jitesh Vadhia, San Jose, CA (US); Emily Fan, Long Island City, NY (US); Lorina Ann Navarro, Brooklyn, NY (US); Kinjal Patel, Matawan, NJ (US)

(73) Assignee: Meta Platforms Technologies, LLC, Menlo Park, CA (US)

(21) Appl. No.: 19/316,719

(22) Filed: Sep. 2, 2025

Related U.S. Application Data
(60) Provisional application No. 63/690,218, filed on Sep. 3, 2024.

(51) Int. Cl. H04N 21/472

(52) U.S. Cl. CPC H04N 21/47217

(57) ABSTRACT

Systems, methods, and computer readable media are disclosed for autoplay configuration. In one embodiment, a system may determine a set of short form videos for presentation, determine a subset of the set to automatically present, determine a length of time to present individual videos of the subset, and cause presentation of the subset of videos for the respective length of time.

### CROSS-REFERENCE TO RELATED APPLICATION

This application claims the benefit of U.S. Application No. 63/690,218, filed Sep. 3, 2024, the entirety of which is incorporated by reference herein.

### TECHNICAL FIELD

The present disclosure generally relates to managing content on a social media platform and, more particularly, managing multiple displays of video content.

### BACKGROUND

Users on social media platforms send and receive content. The content can be text, audio, video or image. When a user interacts with the user interface by scrolling through the display of the platform, the arrangement of the videos and their respective playback can impact the opinion of the user experience. However, not all devices and network conditions can support playing two or more videos at the same time. The device can be constrained memory, processor capability and available bandwidth. Optimizing the user experience includes additional factors that may be implemented to optimize the user experience.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 depicts a simulated screen in which a recipient of user content attempts to screen capture the user's content on the recipient's device.

FIG. 2 depicts an information flow between the application on a client device and a backend server.

FIG. 3 depicts a flowchart implementing a process for upgrading or downgrading of an autoplay customization.

FIG. 4 depicts a table presenting various screens and corresponding autoplay features for different platforms.

FIG. 5 depicts various iterations of surface implementations in accordance with one or more embodiments.

FIG. 6 depicts a process flow of data transfer and communications across mobile devices and backend systems in accordance with one or more embodiments.

FIGS. 7A-7E depict various field values, corresponding descriptions, and device configurations in a table format in accordance with one or more embodiments.

FIGS. 8A-8B depict various data flow and software component feature segmentation in accordance with one or more embodiments.

FIGS. 9-11 depict example data flow and corresponding actions in an example implementation in accordance with one or more embodiments.

### DETAILED DESCRIPTION

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regards to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the included clauses. Various aspects of the subject technology will now be disclosed according to particular but non-limiting examples. Various embodiments described in the present disclosure may be carried out in different ways and variations, and in accordance with a desired application or implementation.

The disclosure can comprise a system that determines a configuration to optimize: 1) the number of videos; 2) a preview length for the video; and 3) the order of the videos and a runtime on a mobile device. The runtime on a user device can be based on dynamic networking conditions, on-device signals and on device static signals. The dynamic networking conditions comprise buffering stalls and adaptive signal quality. The on-device dynamic signals can include available RAM, and the on-device static signals can include the operation of the CPU. The optimization protocol can comprise an iterative approach to toggle between autoplay strategies across multiple mobile surfaces. In initiating the algorithm, the social media platform can consider the overall ration of thumbnails shown in a display versus the thumbnails autoplayed. The platform module would also consider the dynamic working conditions.

When implementing the optimized display platform, the video parameters can comprise: 1) Autoplay across surfaces: explore grid, RISU (Stories), RIFU (feed), Search, Profile; 2) Number of concurrent autoplay videos (e.g., by low-end vs. high-end devices); 3) Video quality (e.g., 60 fps vs 30 fps); 4) Playback length (e.g., 2 s-5 s, whole video, or boomerang); 5) Determining which on-screen videos autoplay (e.g., first video(s), sequential auto-play of next video, sequential auto-play of farthest away video, etc.); 6) Determine whether video advertisements are configured to play and automatic degradation; and 7) Determine whether degradation is occurring. Degradation can occur when the platform evaluates frame drops, memory pressure or operating system crashes.

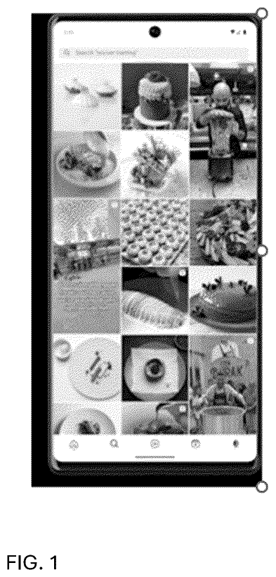

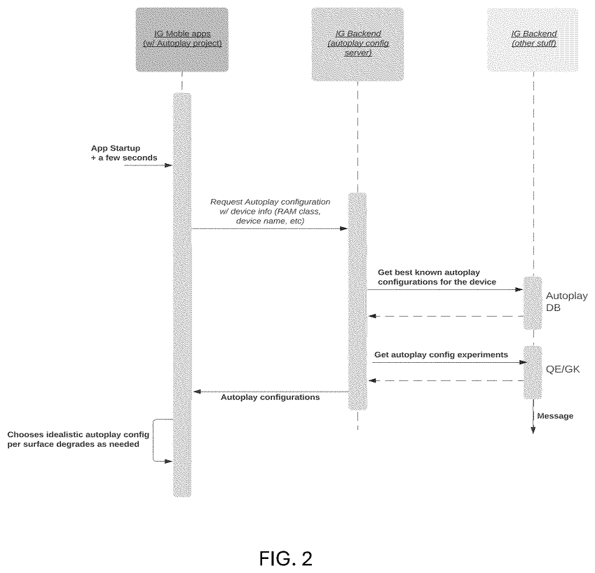

As depicted in FIG. 1, the display of the videos on the user interface can be upgraded, wherein a greater number of videos may play simultaneously. In another aspect, the display of videos can be downgraded such that some of the videos may play simultaneously and the other videos can be presented as still videos. As depicted in FIG. 2, the application on the client device can initiate communication with a backend server that manages the autoplay configuration. The mobile application on the client device can request an autoplay configuration, wherein the request includes data considerations such as: device memory, device operating system, network configurations in addition to video parameters including: video quality, playback length, video thumbnail configuration, etc. The autoplay configurations can be determined by the backend server and sent back to the client device. The client device can then be implemented on the autoplay device.

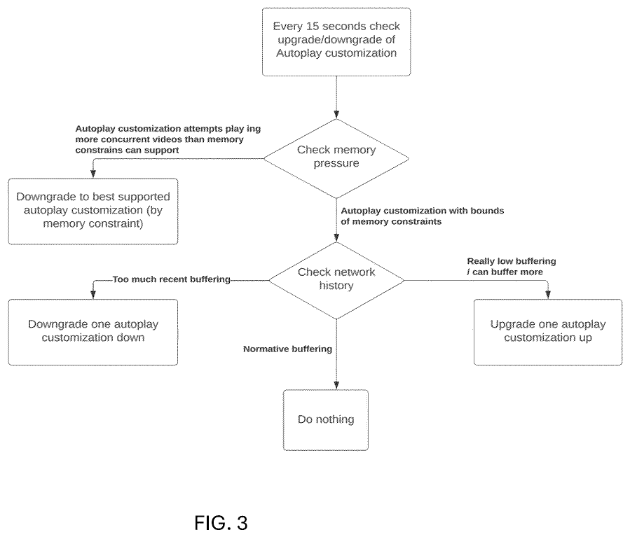

As depicted in FIG. 3, the client device can execute a process or decisions to optimize the playback of thumbnails on the user interface. In particular, the application can iteratively determine if the display of autoplayed thumbnails needs to be upgraded or downgraded. In the first decision, the application may access the memory constraints of the device. As an example, if the memory capacity is below a particular threshold, the autoplay configurations may be downgraded such that less videos are automatically played. Whereas, if the memory is above the same memory threshold, the autoplay configurations can be upgraded allowing for more videos to be played at the same time. In another decision, the application may assess the network capabilities, similar to the memory assessment. If the networking capabilities are below a certain networking threshold, the autoplay configuration can be downgraded. If the networking capabilities are above the networking threshold, the client device has sufficient capacity to send and receive data, permitting an upgrade in customization features.

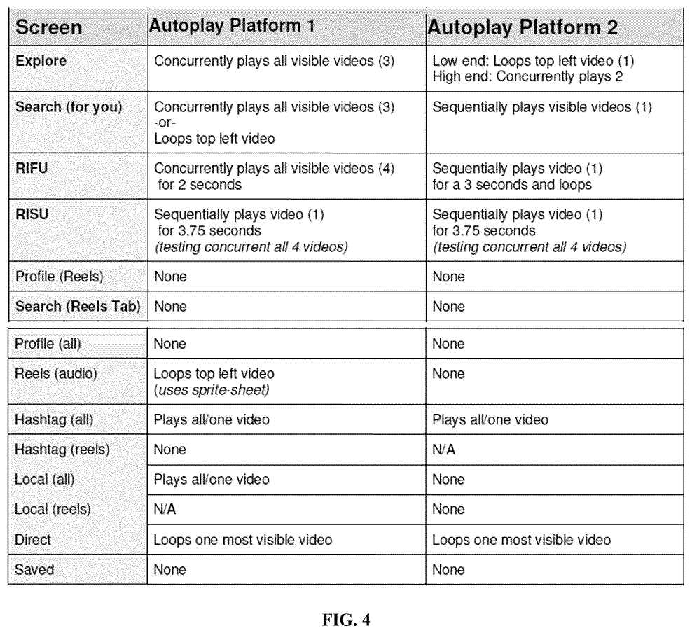

FIG. 4 depicts a table presenting various screens and corresponding autoplay features for different platforms. This disclosure addresses technical issues where social media users, such as Instagram users, may deal with when attempting to preview short form video content, such as short form video content, before deciding whether to watch them in full screen or engage further with video chains. Currently, social media applications may display multiple on-screen video options across more than twelve screens and two platforms, such as mobile platforms (e.g., iOS, Android, etc.). However, there is inconsistency in which videos are previewed, as well as their sequence and preview duration. Embodiments may optimally select short form video content thumbnails for autoplay and tailor this selection to both device and surface, so as to provide users better context for each video. This, in turn, leads to greater satisfaction when deciding to play or skip short form video content. Embodiments include a platform that supports rapid iteration of various autoplay strategies across all mobile surfaces. Embodiments may optimize user experience and engagement metrics, while balancing trade-offs according to different devices and user segments. In some instances, mobile applications show video thumbnails in grids, which users can select to view. Occasionally, some thumbnails autoplay. To reduce user regret and encourage more complete video views, embodiments may determine which thumbnails should automatically play, as well as the timing and duration for each autoplay event.

There are several surfaces within the applications where short form video content do not currently autoplay, or where there is potential to increase the number of autoplays. Embodiments may autoplay thumbnails. Embodiments may maximize the frequency of autoplay across these interfaces. In particular, embodiments may improve performance of autoplay features for low-bandwidth conditions, both on high- and low-end devices. Embodiments may determine optimal selections of videos for autoplay and for how long videos should be played. This feature applies both to full video grids (such as those in the Search short form video content and Hashtag short form video content subtabs) and partial video grids.

Embodiments may prioritize various surfaces, including Explore, Search, Feed (RIFU), and Stories (RISU) across various platforms. Autoplay settings must be customized by surface, platform, device class (high versus low end), and prevailing network conditions. Additional considerations involve adjusting parameters for concurrent video playback, preview duration, and strategies for selecting the next item to autoplay. Embodiments may include live optimization and may incorporate machine learning models for ongoing improvement.

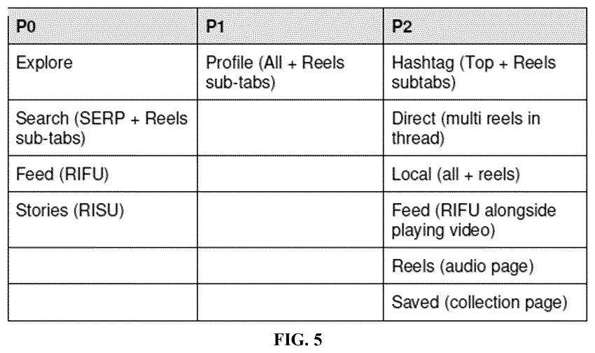

FIG. 5 depicts various iterations of surface implementations in accordance with one or more embodiments. In a first column P0, a first implementation may include certain surfaces, whereas in a second column P1, a second implementation may include additional surfaces, and in a third column P2, a third implementation may include additional surfaces. Any types of surfaces may be included in different implementations.

In the first implementation, surfaces supported for widely-adopted surfaces that share common grid infrastructure. For example, the implementation may support Search+Explore and Feed+Stories since between those two grid infrastructures, the greatest number of surfaces is included. Search (SERP and short form video content subtabs) and Explore (Grid) both share a grid infrastructure which makes it more efficient to build for one and get both. Feed (RIFU), Stories (RISU) all both share grid infrastructure which makes it more efficient to build for one and get both.

In the second implementation, support for screens that are greater engineering effort than the first implementation may be included. For Profile, the all+short form video content subtabs may be updated to include autoplay.

In the third implementation, support for the rest of the applications+technical edge cases may be included. For Saved, accounts for 5% of all short form video content thumbnails previews across the app. For short form video content (audio page): this feature may have less adoption than other screens. For Local (all+short form video content) and Hashtag (top+short form video content), these may be updated to include autoplay support. For Direct (short form video content in direct), embodiments can include two short form video content shared in the same thread onscreen consecutively showing at the same time.

Such implementations have the benefit of, for P0, in particular: Prioritizes surfaces with most engagement for the smallest engineering lift. For P1+P2: features of P0 will make it straightforward to light up more surfaces. Some embodiments mya have different implantation details. For example, for P0: support for existing customizations supported (Surface, OS platform)+low engineering lift at-bats (high end vs. low end, opportunistic reduction). For P1: High end lifts at-bats. For P0, Surface: different surfaces have different autoplay behaviors.

For P0, benefits may include opportunistic reduction based on network conditions, and may provide mobile clients with an ideal autoplay behavior and allow those to opportunistically adjust. Adaptive video playback can be extended to adapting multiple autoplay videos. For detected buffering exceeding a threshold, embodiments may degrade the number of videos, quality, duration, and/or keep looping on screen videos. For dropped frames degrade can be performed accordingly. Embodiments may include concurrent video playback, preview duration, selection strategy.

To select a video for automatic playback, in one example, a top left video may be looped, where the top most visible video is selected and autoplayed. In another example, the most visible video may be looped. Embodiments may autoplay sequential to the next video such as going from top left to bottom right, once one video finishes, play the next one. Or, sequential based on farthest away video: in a 3×3 grid maybe play (1,1), (2,2) and (3,3). For preview duration, embodiments may determine a video duration for autoplay. For example, the entire video may be played and then either loop or choose another video. In another example, a short snippet (2-3 seconds) may be played and then move to the next video or loop. Some embodiments may implement a preview delay so that previews start a ˜second apart to allow users to focus their attention. Some embodiments may use bitrate analysis, such as each video playing decides on its own bitrate, whereas other embodiments may play lowest bitrate possible to accommodate low-end devices to play more than one video in high-bandwidth conditions.

Embodiments may form configurations for each surface based on previous learnings on ideal autoplay experience and test those iteratively. Output signals (performance, engagement and revenue metrics) can be used to determine which is the ideal autoplay configuration. To test, the following may be implemented: Step 1: Gather design constraints and feedback from UXR. Step 2: Experimentation to find the most performing variant based on QE signals. Step 3: Evaluation (UXR Interview/Surveys). QEs signals include: 1. Performance signals (e.g., QEs and performance markers (FVRE, Scroll Perf); 2. Autoplay performance signals; 3. Engagement & revenue signals.

An example of a configuration for Search short form video content subtab (full video grid with 3×4+): Search short form video content should play diagonal videos for 3 s and then move to other video; Search short form video content should play the first video in each row and then loop; Search short form video content should only play 1 video at a time on low-end devices; Search short form video content should play 2 videos with low bit rate on low-end devices. In another example, the full range of autoplay customizations can be tested, and each autoplay optimization can be QE for best engagement.

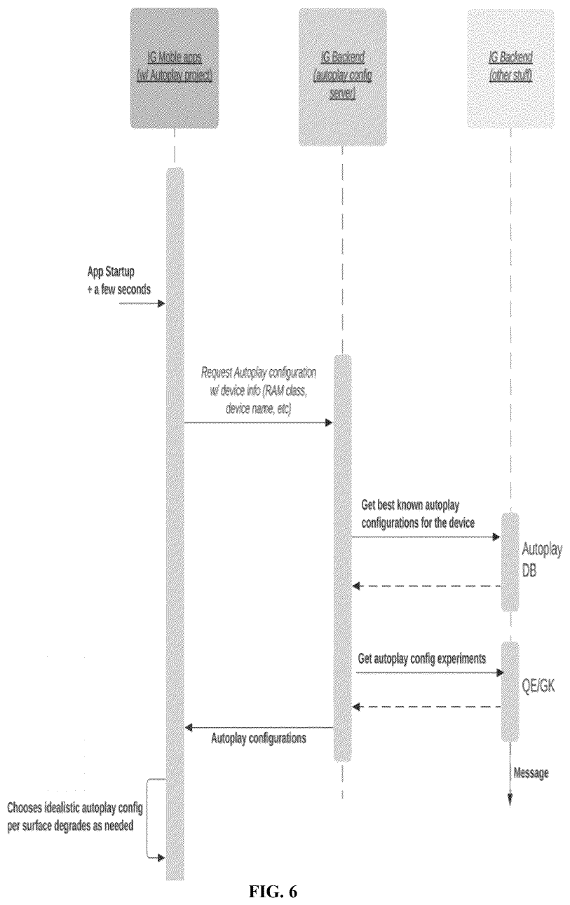

FIG. 6 depicts a process flow of data transfer and communications across mobile devices and backend systems in accordance with one or more embodiments. In one example embodiment, the server-side will provide the client-side with a prioritized autoplay customizations which the client-side can use and then degrade at runtime. The mobile applications will send device info (e.g. RAM class) and the server will respond with a prioritized list of autoplay configurations containing conditionals (e.g. surface), P0 customizations (e.g. # of concurrent videos), global parameters (e.g. video minimum time on screen). The mobile code will be structured so a surface-independent infrastructure (Autoplay Manager) does the majority of the work (loading configs, choosing items to play, etc.), and can include a UI primitive Connector (i.e. Handling the grid of various surfaces), and remainder being surface specific. The server empowers the flexibility of autoplay configurations across platform/surfaces/device class and simplifies experimentation and rollout process. The server-side will provide the client-side with a prioritized autoplay customizations which the client-side can use and then degrade at runtime.

In one example embodiment, a dumb client implementation may be used. Mobile requests autoplay customizations from the server with device+user info (e.g. ram class, platform, etc.). Server responds with one autoplay configuration for each surface and the mobile apps follow that configuration exactly. This approach may lack flexibility: If the mobile apps has to obey the autoplay configuration without modification, by definition the mobile apps can't respond to changes at real time (e.g. network conditions like switching from WiFi to cellular). There may also be a higher bar of accuracy: the accuracy of server supplied autoplay configurations have to be very high because the mobile apps have to comply.

For a smart client implementation, the mobile device examines the current grid structure (3×4? Diagonal short form video content? Only one reel?), the device capabilities, network conditions, and chooses at runtime the correct autoplay configuration. This can be difficult to experiment with without new mobile releases, and may lack remote control.

In a third Semi-Smart Client implementation, the mobile device requests autoplay customizations from the server with device+user info (e.g. ram class, platform, etc.). Server responds with multiple prioritized autoplay configurations for each surface and the mobile apps can degrade between configurations as needed.

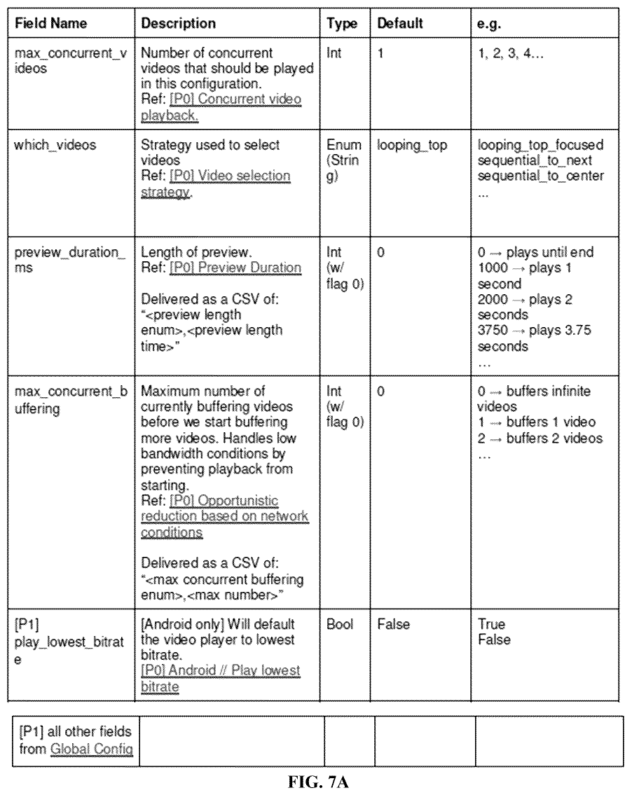

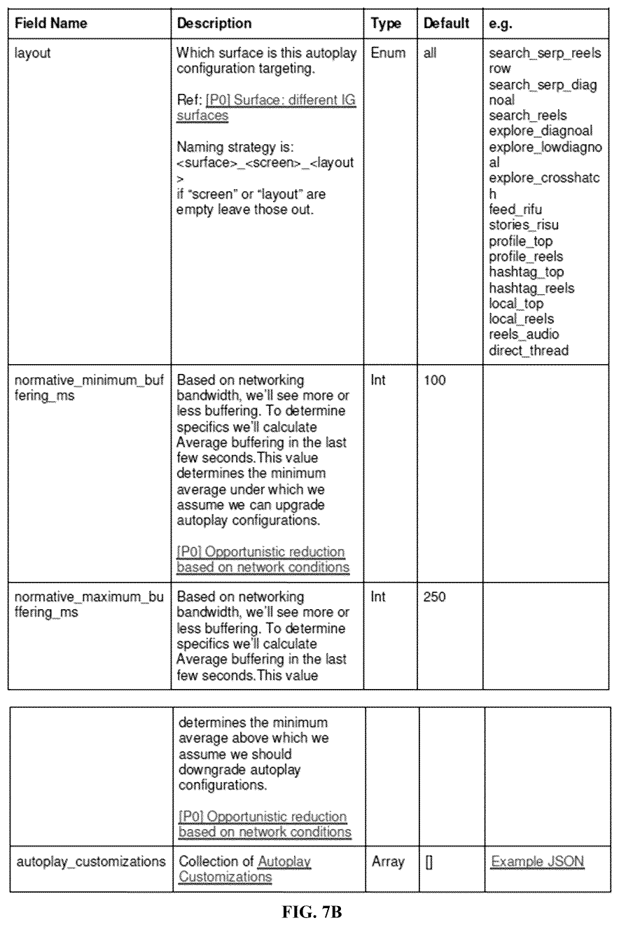

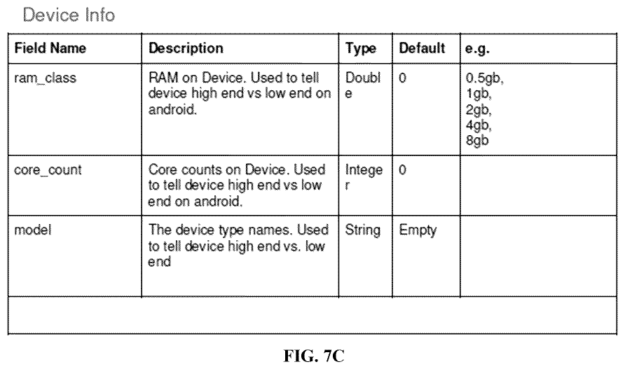

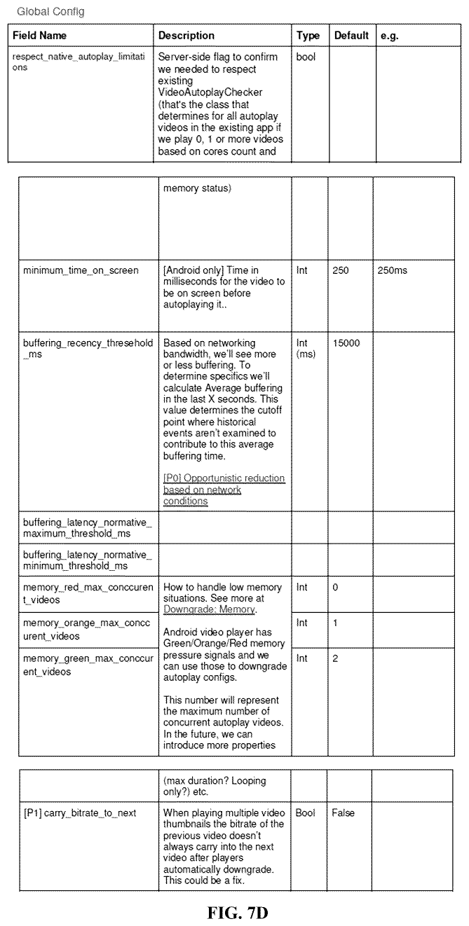

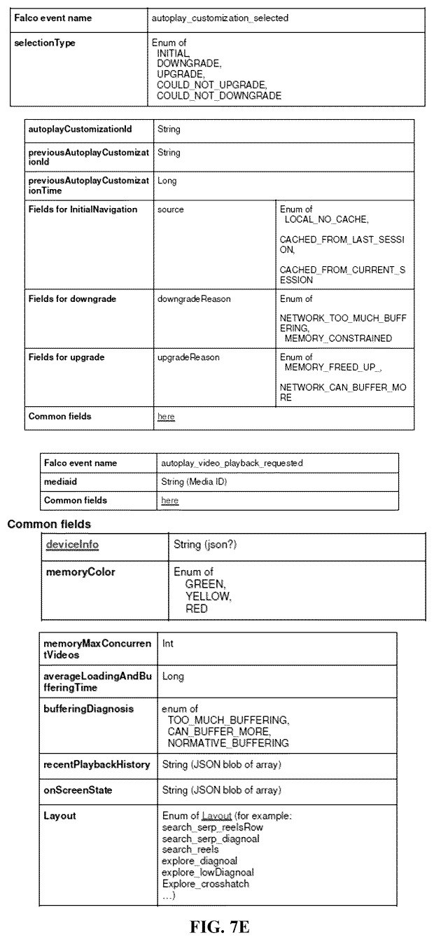

FIGS. 7A-7E depict various field values, corresponding descriptions, and device configurations in a table format in accordance with one or more embodiments. For Server to Mobile Autoplay Configuration Specification, the mobile applications will send device info (e.g. RAM class) and the server will respond with a prioritized list of autoplay configurations containing conditionals (e.g. surface), P0 customizations (e.g. # of concurrent videos), global parameters (e.g. video minimum time on screen). In this sample JSON an iPhone 12 with 4 GB of RAM is asking for autoplay configurations. It receives the following search short form video content surface configuration: First try, 3 concurrent videos with 5 seconds preview and then play the video farthest away. Next try, 2 concurrent videos with 3 seconds preview and play the next video. Finally try, 1 concurrent video with 2 seconds preview and then loop the video.

For Mobile to Server Logging, the core of Autoplay experimentation process allows for hypothesis, testing, and iterating on autoplay configuration for devices. For Autoplay Configuration selected on screen navigation: once a user navigated to a screen an autoplay configuration that was applied and it's source can be logged. Source could be either from server, it could be cached from previous sessions, or it could be the local overrides. For Autoplay configuration selected due to downgrade: Once an autoplay configuration has been selected, the mobile client can choose to downgrade. For Autoplay configuration selected due to upgrade: Mobile clients can choose to upgrade autoplay configuration and this can also be logged. For Autoplay configurations that couldn't upgrade or downgrade due to lack of options. One option is that three separate events can be created with a hard-enforced schema. Another option is creating a single event with a loose schema. For a Video selected when requesting video playback, autoplayCustomizationId, Memory details, Buffering details, and String JSON: what's on-screen, playback status can be determined.

Queries for: 1. Feedback for configuration: Counting the number of upgrades and downgrades per sessions. Strong signal on configuration improvements or regressions for a cohort. Counting autoplay_customization_selected with upgrades or downgrades. 2. Debugability: was the downgrade or upgrade in the right place? Specifically the following can be used: video_started_playing: with subtype=“minor_unit” and reason=“autoplay” is for small autoplay previews. There's also start_delay there can be used to validate client side choices around buffering. quality_summary: can be used to see how playback on autoplay units worked out. Specifically buffer_duration_ms. Surface specific events can be used to know which Thumbnails are presented to the user. Instagram_clips_animated_grid_unit_impression: has the media ID when showing short form video content grid thumbnails to the user.

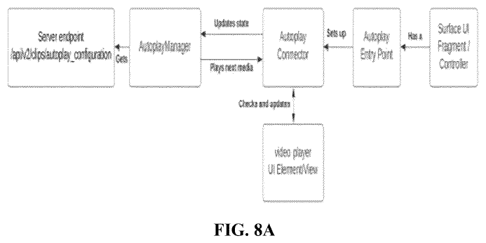

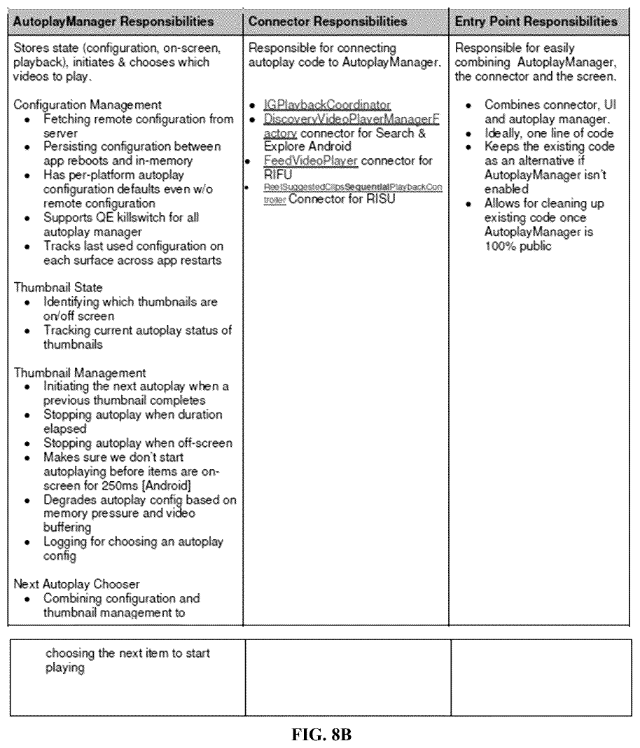

FIGS. 8A-8B depict various data flow and software component feature segmentation in accordance with one or more embodiments. For Mobile Architecture, lots of Autoplay code exists within the top-level screens or is centralized using IGPlaybackCoordinator infrastructure. Embodiments may have a Architecture: AutoplayManager, where Autoplay Manager infrastructure on both platforms that could plug into the existing classes and support dynamically choosing which videos to play, how many videos, and for how long.

Entry points are ideally short placeholders that wire up Connectors, AutoplayManager and existing Autoplay code they're replacing. For example this code in ExploreFragment is responsible for Explore Android autoplay today. This approach provides Entry point code can encapsulate checking the Autoplay server config, cached config and QE killswitch. Entry point code can be used in the future to find dead autoplay code and delete it. Connector Sample code Most surfaces today have code that coordinates autoplay logic. The goal of connectors is to implement those same interfaces, but have those provide information and be powered by AutoplayManager. For example this code in IGDiscoveryGridViewController (Search and Explore) uses IGPlaybackCoordinator strategy for handling For Grids: the connector that replaces IGDiscoveryGridPlaybackCoordinatorStrategy, embodiments may reimplement IGPlaybackCoordinatorStrategy. The main point of reimplementation would be instead of checking UI state directly and then deciding on media playback, embodiments may update the AutoplayManager with UI State and then have it decide on the state of the current item. The benefits of this approach allows for use of all the existing Autoplay code on platforms, while augmenting it with additional state management.

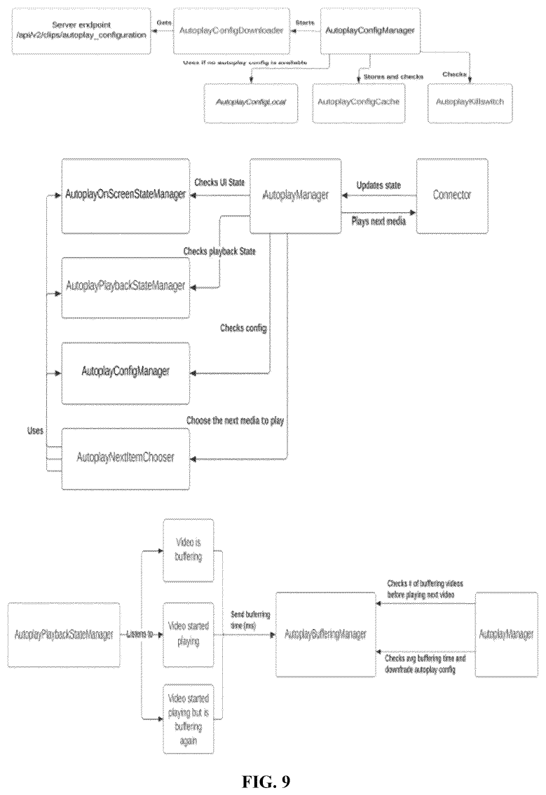

FIGS. 9-11 depict example data flow and corresponding actions in an example implementation in accordance with one or more embodiments. In FIG. 9. each short form video content thumbnails layout to have distinct autoplay customizations. There are three types of surfaces to support: 1. Surfaces with one-screen and one-layout. For example RIFU and RISU only show up in one layout. Surfaces with multiple screens with a single layout. For example Profile short form video content subtab is a grid composed exclusively of short form video content; whereas Profile All/Top subtab is a mixture of short form video content, photos and carousels. 3. Surfaces with one or more screen with multiple layouts. E.g. Explore has three layouts: Low Diagonal with 1 short form video content in every 3×4, Diagonal with 2 short form video content in every 3×4, and Crosshatch with 3 short form video content in every 3×4. One responsibility of connectors is determining which layout the current surface is using. For the primitive case of surfaces with only one layout (RIFU, RISU) AutoplayManager Layout can be set to default. For surfaces with dynamic server-driven layouts (Explore, Search) connectors should examine server-responses and then set layouts. AutoplayManager In rough sketch here are the extra classes that may be included: Configuration Management; AutoplayConfigManager: facade for classes shown; AutoplayConfigDownloader: Fetching remote configuration from server; AutoplayConfigCache: Persisting configuration between applications reboots and in-memory; AutoplayKillswitch: Supports QE killswitch for all autoplay manager; AutoplayConfigLocal: supports per-platform autoplay configuration defaults even w/o remote configuration; Thumbnail State; AutoplayOnScreenStateManager: Identifying which thumbnails are on/off screen; AutoplayPlaybackStateManager: Tracking current autoplay status of thumbnails; Thumbnail Management AutoplayManager: uses Thumbnail State, Configuration management and next item chooser; Initiating the next autoplay when a previous thumbnail completes; Stopping autoplay when duration clapsed; Stopping autoplay when off-screen. Embodiments may include Next Autoplay Chooser-AutoplayNextItemChooser: Combining configuration and thumbnail management to choosing the next item to start playing; Testing-AutoplayManager: The benefits of this approach is that everything in the AutoplayManager layer is completely unit testable. Connector code & entry point code: depending on how tightly coupled the existing code is to UI state, this code might be unit testable.

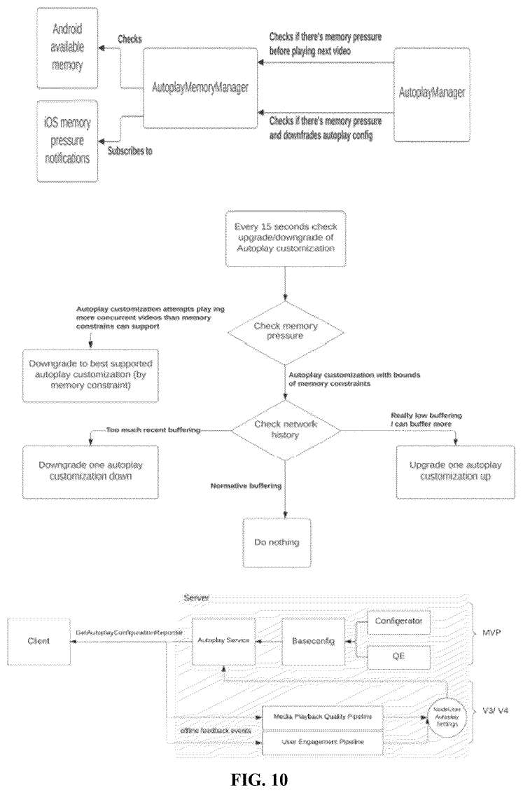

In FIG. 10, a side effect of additional autoplay beyond FVRE is an increase in FAD % which are out of memory crashes. To avoid crashing the applications due to memory pressure, embodiments may check available memory as % of total memory (Android) and memory pressure notifications and then downgrade appropriately or not play additional videos at all.

For Downgrading & Upgrading: Memory+Network: Memory pressure provides hard limits to how many concurrent videos can be autoplayed. Network bandwidth provides a signal to upgrade or downgrade the autoplay configuration (number of concurrent videos, looping behaviors, duration, etc.). Memory has precedence over networking and sets the available range of autoplay customization; whereas networking buffering explore a dynamic range of upgrades/downgrades. Embodiments may combine those via Server Architecture-Device Class Configurations Requirements (platformize all the video autoplay across application using a scalable architecture to power existing and new use cases, such as: Support different autoplay configurations for different surfaces X different device classes X real-time conditions (network); Existing surfaces that do not have autoplay (ex: Profile); New surfaces that haven't been built yet; Device configurations does not exist before; Fullback rules that evolve overtime: Embodiments may add new autoplay configurations for specific surface/platform and change the fallback rules.

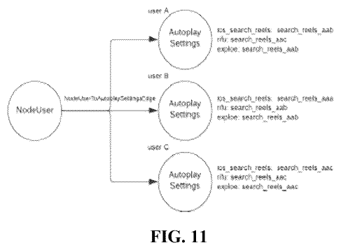

In FIG. 11, another implementation option can be used to reduce complexity by keeping a single fallback sequence for a surface+platform. For different device class, it maps to different subsets of the fallback sequence. The Configerator can be similar to FIG. 10 but without device_class. The triage based on device limitation will delegate to Client completely. For Server-side coded autoplay templates, and User Autoplay States, the highest quality autoplay template id of a fallback sequence can be kept in Autoplay Setting Node for each user. One benefit of storing user autoplay states is when applications start, the optimal snapshot of templates can be sent to client when applications start.

For Autoplay Service, logic can be implemented to generate fallback list on Autoplay Service. The complete fallback list can be retrieved by platform+surface, and the optimal state stored in Autoplay Settings Node can be used to slice the fallback list. For example, for Android Search short form video content fallback sequence: [autoplay_template_1, autoplay_template_2, autoplay_template_3]. User X's past autoplay config on Android Search short form video content is autoplay_template_2. The configuration sequence server sends down client will be: [autoplay_template_2, autoplay_template_3]. To handle initialization on applications starts, the snapshot of the optimal autoplay configuration for a platform can be pulled and sent to Client on applications start. The response will be a light-weight JSON for Client to quickly apply. If there is no existing state, the highest (or default) autoplay template can be sent to users.

Embodiments may include preconfigured settings stored on Configerator and allow QE to override the settings for experimentations. Embodiments may store production configuration on Configerator and leverage BaseConfig to control the override flow of parameters. The default configuration comes from the setting stored on Configerator, and can be overridden by QE for experimentations. User states will be stored in Nodes. In the Autoplay Setting Node, the mapping of each surface and its latest applied configuration can be stored. Embodiments may include data pipelines to have feedback from Client to dynamically adjust the configurations. In one example, all the autoplay templates for each platform/surface/tier can be stored on Configerator. The fallback logic and version control logic will be implemented on Autoplay Manager Service. Server will send down an ordered list of autoplay templates starting with the highest possible quality Serve thinks Client should start triage with. Client can fallback to lower quality ones based on the actual video playback feedback. Fallback sequences can be stored on Configerator and autoplay templates in code.

The accompanying appendix, which is included to provide further understanding of the subject technology and is incorporated in and constitutes a part of this specification, illustrates aspects of the subject technology and together with the description serve to explain the principles of the subject technology.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

The word “exemplary” is used herein to mean “serving as an example or illustration.” Any aspect or design described herein as “exemplary” is not necessarily to be construed as preferred or advantageous over other aspects or designs. In one aspect, various alternative configurations and operations described herein may be considered to be at least equivalent.

As used herein, the phrase “at least one of” preceding a series of items, with the term “or” to separate any of the items, modifies the list as a whole, rather than each item of the list. The phrase “at least one of” does not require selection of at least one item; rather, the phrase allows a meaning that includes at least one of any one of the items, and/or at least one of any combination of the items, and/or at least one of each of the items. By way of example, the phrase “at least one of A, B, or C” may refer to: only A, only B, or only C; or any combination of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user. Method clauses may be provided to present elements of the various steps, operations, or processes in a sample order, and are not meant to be limited to the specific order or hierarchy presented.

All structural and functional equivalents to the elements of the various aspects described throughout this disclosure that are known or later come to be known to those of ordinary skill in the art are expressly incorporated herein by reference and are intended to be encompassed by the included clauses. Moreover, nothing disclosed herein is intended to be dedicated to the public regardless of whether such disclosure is explicitly recited in the clauses. No clause element is to be construed under the provisions of 35 U.S.C. § 112 (f) unless the element is expressly recited using the phrase “means for” or, in the case of a method, the element is recited using the phrase “step for.” Furthermore, to the extent that the term “include,” “have,” or the like is used, such term is intended to be inclusive in a manner similar to the term “comprise” as “comprise” is interpreted when employed as a transitional word in a clause.

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the clauses. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any clause. Rather, as the clauses reflect, inventive subject matter lies in less than all features of a single disclosed configuration or operation. The clauses are hereby incorporated into the Detailed Description, with each clause standing on its own to represent separately patentable subject matter.

The clauses are not intended to be limited to the aspects described herein but are to be accorded the full scope consistent with the language of the clauses and to encompass all legal equivalents. Notwithstanding, none of the clauses are intended to embrace subject matter that fails to satisfy the requirement of 35 U.S.C. § 101, 102, or 103, nor should they be interpreted in such a way.

That which is claimed is:

1. A system comprising:
memory comprising computer-executable instructions;
one or more processors coupled to the memory, the one or more processors configured to execute the computer-executable instructions to:
determine a set of short form videos for presentation;
determine a subset of the set to automatically present;
determine a length of time to present individual videos of the subset; and
cause presentation of the subset of videos for the respective length of time.
